(19) United States
(12) Patent Application Publication
(10) Pub. No.: US 2013/0319838 A1
(43) Pub. Date: Dec. 5, 2013

(54) PRESS KEY

(71) Applicant: Qing ZHANG, Changshu (CN)

(72) Inventor: Qing ZHANG, Changshu (CN)

(21) Appl. No.: 13/484,796

(22) Filed: May 31, 2012

(51) Int. Cl. H01H 13/02

(52) U.S. Cl. 200/520

(57) ABSTRACT

A press key includes: a base unit; a circuit board disposed on the base unit; a keycap disposed on the circuit board and movable between a raised position and a pressed position; an elastic restoring unit disposed between the keycap and the circuit board, and capable of providing a restoring force to move the keycap to the raised position; and a guiding mechanism to guide the movement of the keycap. The guiding mechanism includes at least one guiding unit disposed on one of the keycap and the base unit, and at least one engaging unit disposed on the other one of the keycap and the base unit.

### BACKGROUND OF THE INVENTION

1. Field of the Invention

This invention relates to a press key, more particularly to a thin-type press key.

2. Description of the Related Art

A conventional press key can produce an input signal by virtue of pressing a keycap. For next pressing, the keycap should be returned to its original position after the keycap is released. Accordingly, a press key usually includes an elastic restoring mechanism for returning the keycap to the original position, and a guiding mechanism for guiding movement of the keycap.

Normally, a scissors-type structure serves as the guiding mechanism of the press key. However, the scissors-type structure is relatively complex in terms of manufacturing and assembling processes, and renders the press key to have a relatively large thickness.

For meeting the miniaturizing requirement of portable electronic information devices, many efforts are focused on how to simplify the structure and reduce the overall thickness of the press key.

### SUMMARY OF THE INVENTION

Therefore, an object of the present invention is to provide a press key that can overcome the aforesaid drawbacks associated with the prior art.

Accordingly, the press key of this invention comprises:

a base unit;

a circuit board disposed on the base unit;

a keycap disposed on the circuit board and movable between a raised position and a pressed position;

an elastic restoring unit disposed between the keycap and the circuit board, and capable of providing a restoring force to move the keycap to the raised position; and

a guiding mechanism to guide movement of the keycap, the guiding mechanism including at least one guiding unit disposed on one of the keycap and the base unit, and at least one engaging unit disposed on the other one of the keycap and the base unit, the guiding unit and the engaging unit movably engaging with each other.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is an exploded perspective view of the first preferred embodiment of a press key of this invention;

FIG. 2 is a top view of the press key of FIG. 1;

FIG. 3 is a cross-sectional view taken along line III-III in FIG. 2;

FIG. 4 is an exploded perspective view of the second preferred embodiment of the press key of this invention;

FIG. 5 is a top view of the second preferred embodiment;

FIG. 6 is a cross-sectional view taken along line VI-VI in FIG. 5;

FIG. 7 an exploded perspective view of the third preferred embodiment of the press key of this invention;

FIG. 8 is a top view of the press key of FIG. 7;

FIG. 9 is a cross-sectional view taken along line IX-IX in FIG. 8;

FIG. 10 is an exploded perspective view of the fourth preferred embodiment of the press key of this invention;

FIG. 11 is a top view of the press key of FIG. 10;

FIG. 12 is a cross-sectional view taken along line XII-XII in FIG. 11;

FIG. 13 is an exploded perspective view of the fifth preferred embodiment of the press key of this invention;

FIG. 14 is a top view of the press key of FIG. 13;

FIG. 15 is a cross-sectional view taken along line XV-XV in FIG. 14;

FIG. 16 is an exploded perspective view of the sixth preferred embodiment of the press key of this invention;

FIG. 17 is a top view of the press key of FIG. 16;

FIG. 18 is a cross-sectional view taken along line XVIII-XVIII in FIG. 17;

FIG. 19 is an exploded perspective view of the seventh preferred embodiment of the press key of this invention;

FIG. 20 is a top view of the press key of FIG. 19;

FIG. 21 is a cross-sectional view taken along line XXI-XXI in FIG. 20;

FIG. 22 is an exploded perspective view of the eighth preferred embodiment of the press key of this invention;

FIG. 23 is a top view of the press key of FIG. 22; and

FIG. 24 is a cross-sectional view taken along line XXIV-XXIV in FIG. 23.

### DETAILED DESCRIPTION OF THE PREFERRED EMBODIMENTS

Before the present invention is described in greater detail with reference to the accompanying preferred embodiments, it should be noted herein that like elements are denoted by the same reference numerals throughout the disclosure.

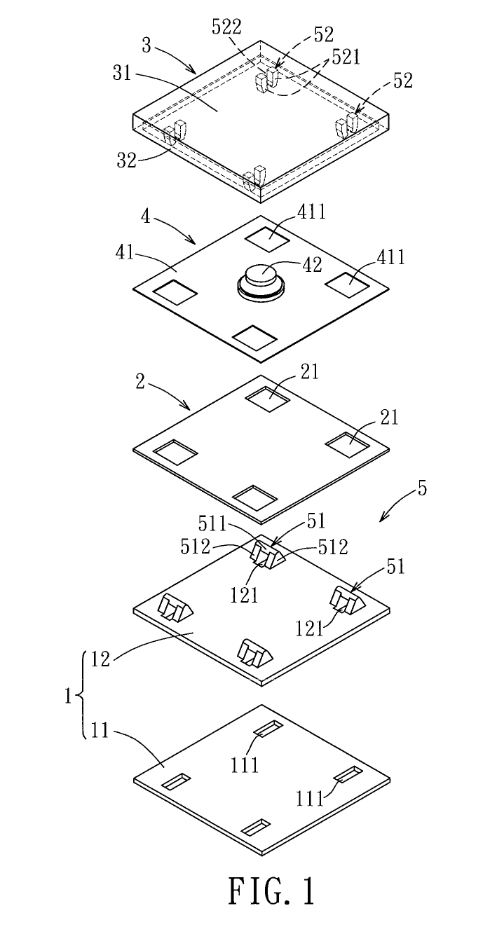

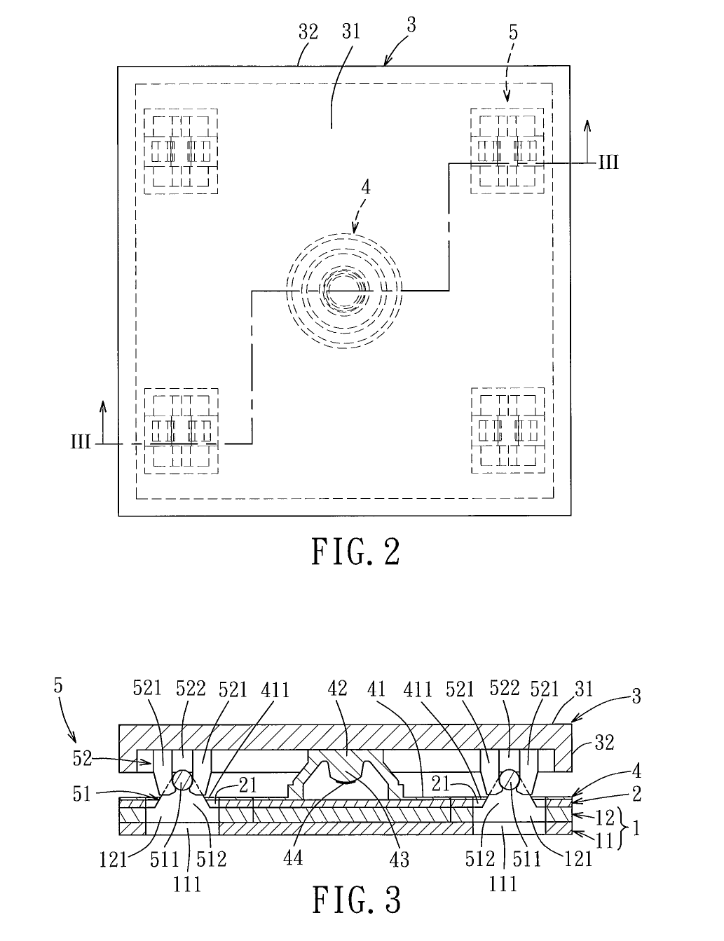

Referring to FIGS. 1 to 3, the first preferred embodiment of a press key according to this invention comprises a base unit 1, a circuit board 2, a keycap 3, an elastic restoring unit 4 and a guiding mechanism 5.

The base unit 1 includes a metal sheet 11 and a plastic substrate 12 disposed on the metal sheet 11, and is used for supporting the circuit board 2, the keycap 3 and the elastic restoring unit 4.

The circuit board 2 is a thin-film circuit board. The keycap 3 is disposed on the circuit board 2, and has a plate body 31 and an annular flange 32 extending downwardly and annularly from a periphery of the plate body 31.

The keycap 3 is movable between a raised position and a pressed position. The elastic restoring unit 4 is disposed between the circuit board 2 and the keycap 3 at a position corresponding to a central portion of the keycap 3 to support the keycap 3 such that the circuit board 2 is spaced apart from the keycap 3. When the keycap 3 is moved to the pressed position in accordance with user operation, the elastic restoring unit 4 is deformed to contact the circuit board 2 such that the circuit board 2 produces an electrical signal. After the keycap 3 is released from the pressed position, the elastic restoring unit 4 provides a restoring force to restore the keycap 3 to the raised position.

In this embodiment, the elastic restoring unit 4 includes an elastic sheet 41, a truncated cone-shaped hollow body 42, a contact 43, and a conductive layer 44. The elastic sheet 41, the truncated cone-shaped hollow body 42 and the contact 43 are formed in one-piece using rubber material. The truncated cone-shaped hollow body 42 protrudes upwardly from the plastic sheet 41 and abuts against the keycap 3. The contact 43 protrudes downwardly from an inner face of a top side of the truncated cone-shaped hollow body 42. The conductive layer 44 covers a bottom end of the contact 43. The contact 43 and the conductive layer 44 are moved to contact the circuit board 2 to generate an electrical signal when the keycap 3 is at the pressed position. In other words, when the keycap 3 is pressed downwardly, the elastic restoring unit 42 is thus deformed to move down the contact 43, such that the bottom end of the contact 43 together with the conductive layer 44 are electrically connected to the circuit board 2 to produce an electrical signal. After the keycap 3 is released, the elastic truncated cone-shaped hollow body 42 restores to its original shape to move the keycap 3 to the raised position, and the conductive layer 44 is separated from the circuit board 2. In this embodiment, the circuit board 2 is a single layer. In other embodiments, the conductive layer 44 may be dispensed with. In such case, the circuit board 2 maybe a thin-film circuit board including an upper layer, a lower layer and a middle layer disposed between the upper and lower layers. The middle layer is formed with a through hole in a position corresponding to the contact 43 of the elastic restoring unit 42, and the electrical signal is produced while the upper and lower layers are brought into contact with each other through the through hole.

The guiding mechanism 5 is disposed along a periphery of the elastic restoring unit 4 to guide movement of the keycap 3, and includes at least one guiding unit 52 disposed on one of the keycap 3 and the base unit 1, and at least one engaging unit 51 disposed on the other of the keycap 3 and the base unit 1. The guiding unit 52 and the engaging unit 51 movably engage with each other. In this embodiment, the guiding mechanism 5 includes four of the guiding units 52 disposed on a lower surface of the plate body 31 of the keycap 3, and four of the engaging units 51 disposed on an upper surface of the plastic substrate 12 of the base unit 1. Each of the guiding units 52 is formed with a guiding groove 522, and includes two spaced apart protrusions 521 each having a free end bent toward the other of the protrusions 521. The protrusions 521 of each guiding unit 52 extend downwardly from the lower surface of the plate body 31, and cooperatively define the guiding groove 522. Each of the engaging units 51 includes a shaft member 511, and two spaced apart supporting members 512 extending upwardly from the upper surface of the plastic substrate 12 to support two opposite ends of the shaft member 511 such that the shaft member 511 is disposed substantially parallel to the upper surface of the plastic substrate 12. The shaft member 511 of each of the engaging units 51 engages the guiding groove 522 of a respective one of the guiding units 52 such that each of the guiding units 52 is in sliding engagement with the shaft member 511 of a respective one of the engaging units 51. In this embodiment, the engaging units 51 are formed in one piece with the plastic substrate 12, and the guiding units 52 are formed in one piece with the keycap. For extension of the elements of the guiding mechanism 5, the circuit board 2 is formed with four through holes 21, and the elastic sheet 41 is formed with four through holes 411. Besides, the metal sheet 11 is formed with four through slots 111, and the plastic substrate 12 is formed with four through slots 121 that are respectively aligned with the through slots 111. The through slots 111, 112 are provided for extension of the guiding units 52.

Movement of the keycap 3 will now be described. As best shown FIG. 3, each of the guiding units 52 is guided by the shaft member 511 of a respective one of the engaging units 51, such that a left-to-right movement of the keycap 3 is limited. On the other hand, since the two protrusions 521 of each of the guiding units 52 are designed to be disposed between the two supporting members 512 of a respective one of the engaging units 51, front-to-rear movement of each of the guiding units 52 is limited by the supporting members 512 of the respective one of the engaging units 51. Accordingly, front-to-rear movement of the keycap 3 is limited. When the keycap 3 is moved to the pressed position, each of the guiding units 52 can be guided by the shaft member 511 of the respective one of the engaging units 51 to extend into a respective one of the through slots 111 and a respective one of the through slots 121. Therefore, the keycap 3 is limited to move in an up-to-down direction.

Moreover, because the free ends of the protrusions 521 of each of the guiding units 52 can be elastically deformed, the shaft member 511 of each of the engaging units 51 can be press-fitted into the guiding groove 522 defined by the protrusions 521 of the respective one of the guiding units 52 during an assembling process of the press key. After the assembling process, the bent free ends of the protrusions 521 of each of the guiding units 52 can prevent removal of the shaft member 511 of the respective one of the engaging units 51 from the respective one of the guiding grooves 522, unless forces opposite to the force to press-fit the shaft members 511 into the guiding grooves 522 are applied to remove the shaft members 511 from the guiding grooves 522.

With the guiding mechanism 5 and the elastic restoring unit 4, the keycap 3 is capable of moving between the raised position and the pressed position relative to the base unit 1. When the keycap 3 is at the raised position, two forces applied to the keycap 3 are balanced. One is an upward force provided by the elastic restoring unit 4, and the other is a gripping force to retain the shaft members 511 in the guiding grooves 522.

When the keycap 3 is subjected to an external force to move the pressed position, the guiding units 52 can be moved downwardly relative to the engaging units 51.

In this embodiment, the engaging units 51 are disposed on the base unit 1, and the guiding units 52 are disposed on the keycap 3. However, in other embodiments, the engaging units 51 can be disposed on the keycap 3 and the guiding units 52 can be disposed on the base unit 1.

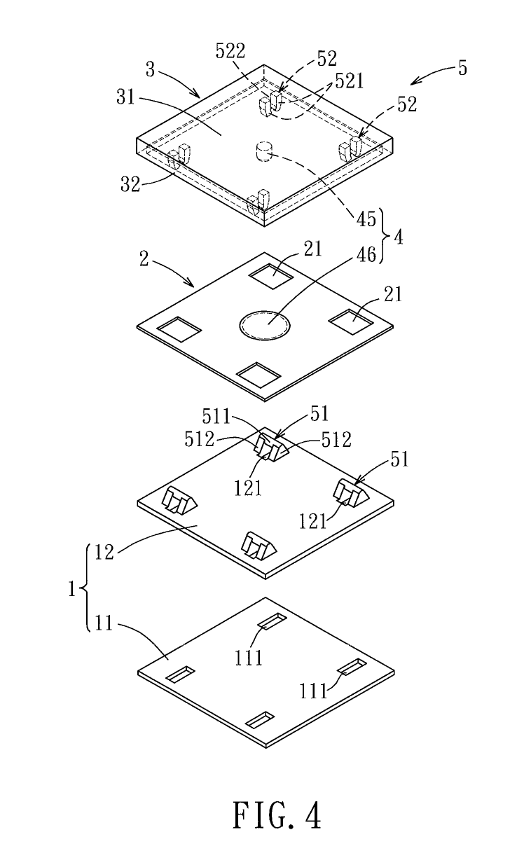

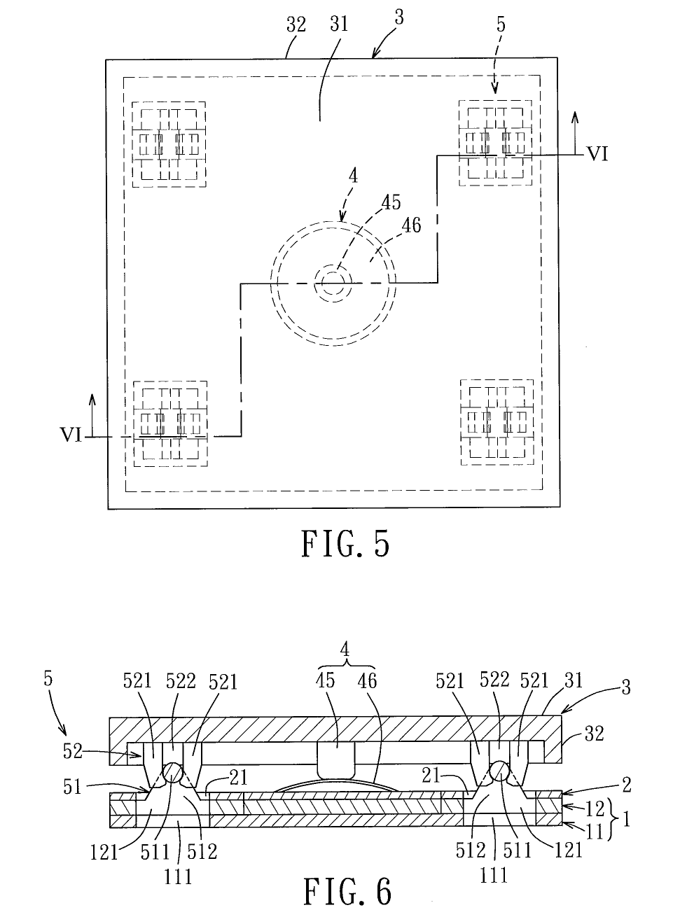

FIGS. 4 to 6 illustrate the second preferred embodiment of the press key according to this invention. The second preferred embodiment differs from the first preferred embodiment in that the elastic restoring unit 4 has a different configuration. In this embodiment, the elastic restoring unit 4 includes a press member 45 and a springy metal dome 46. The press member 45 protrudes from the lower surface of the plate body 31 of the keycap 3. The springy metal dome 46 is disposed on the circuit board 2. When the keycap 3 is at the pressed position, a central portion of the springy metal dome 46 is pressed by the press member 45 to contact the circuit board 2. After the keycap 3 is released, the springy metal dome 46 restores to its original shape by virtue of its restoring force to move up the press member 45, and to move the keycap 3 to the raised position.

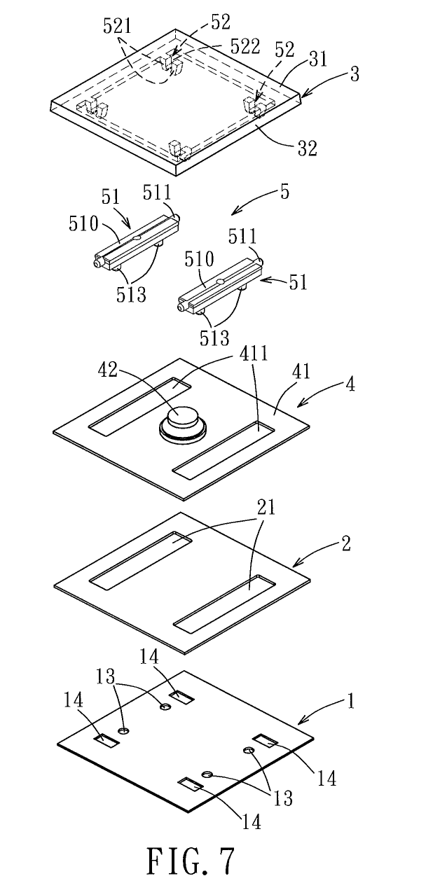

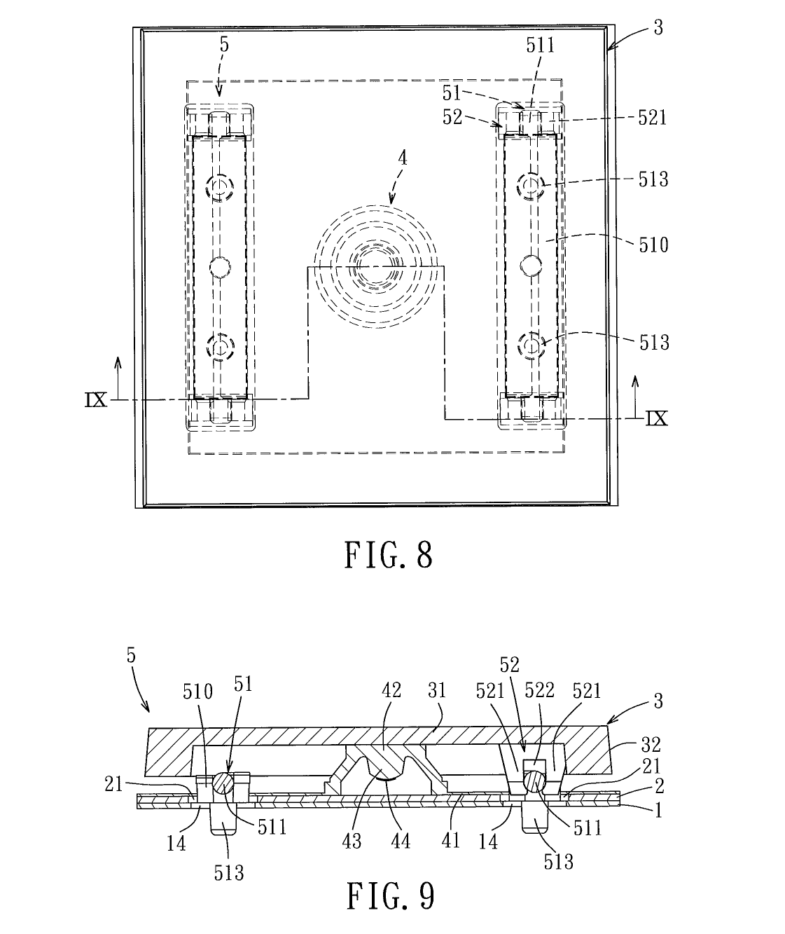

FIGS. 7 to 9 illustrate the third preferred embodiment of the press key according to this invention. The third preferred embodiment differs from the first preferred embodiment in that the guiding mechanism 5 includes four of the guiding units 52 and two of the engaging units 51. In this embodiment, each of the engaging units 51 includes a shaft member 511 and a supporting body 510. The shaft member 511 has two opposite ends that engage respective two of the guiding units 52. The supporting body 510 supports the shaft member 511, and a bottom surface of the supporting body 510 is formed with two pillars 513. The base unit 11 is a single plate, and is formed with four mounting holes 13 to receive the pillars 513 of the engaging units 51, and four through slots 14 for extension of the guiding units 52.

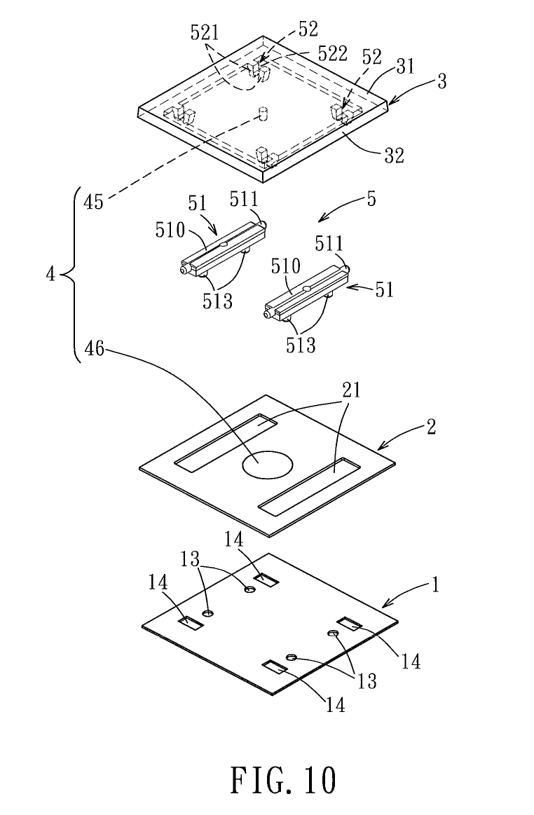

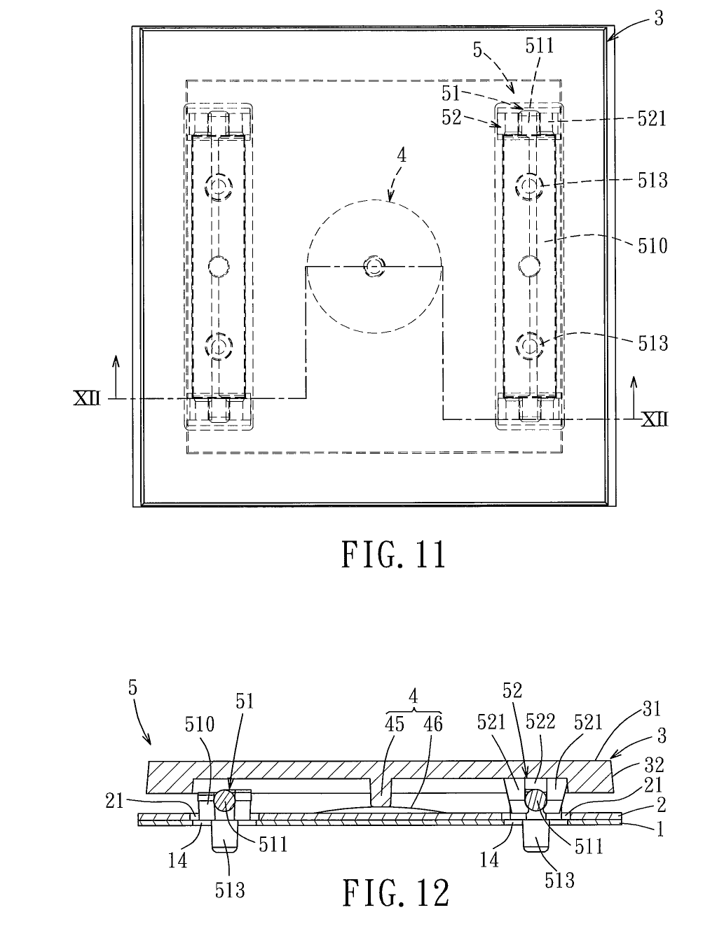

FIGS. 10 to 12 illustrate the fourth preferred embodiment of the press key according to this invention. The fourth preferred embodiment differs from the third preferred embodiment in that the elastic restoring unit 4 has a different configuration. In this embodiment, the elastic restoring unit 4 is identical to that in the second preferred embodiment.

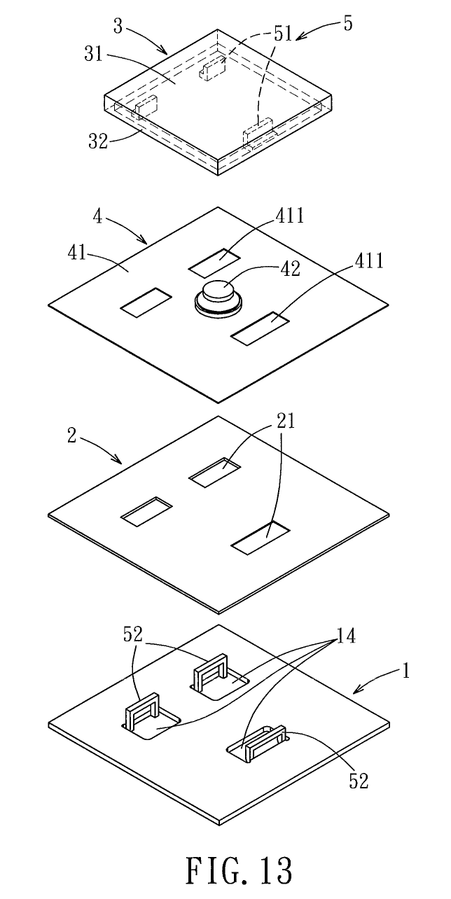

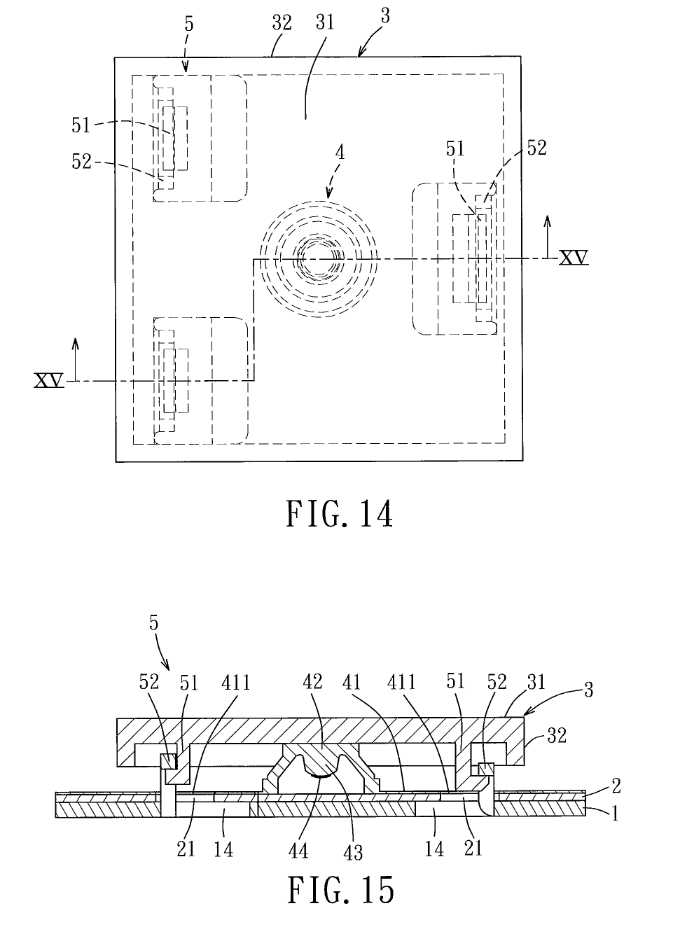

FIGS. 13 to 15 illustrate the fifth preferred embodiment of the press key according to this invention. The fifth preferred embodiment differs from the third preferred embodiment in that the guiding mechanism 5 includes three of the guiding units 52 and three of the engaging units 51. The guiding units 52 are disposed on the upper surface of the base unit in a triangular formation, and each of the guiding units 52 is formed with a guiding slot. Each of the engaging units 51 is disposed on the lower surface of the plate body 31 of the keycap 3 at a position corresponding to a respective one of the guiding units 52, and is an engaging hook movably engaging the guiding slot of the respective one of the guiding units 52.

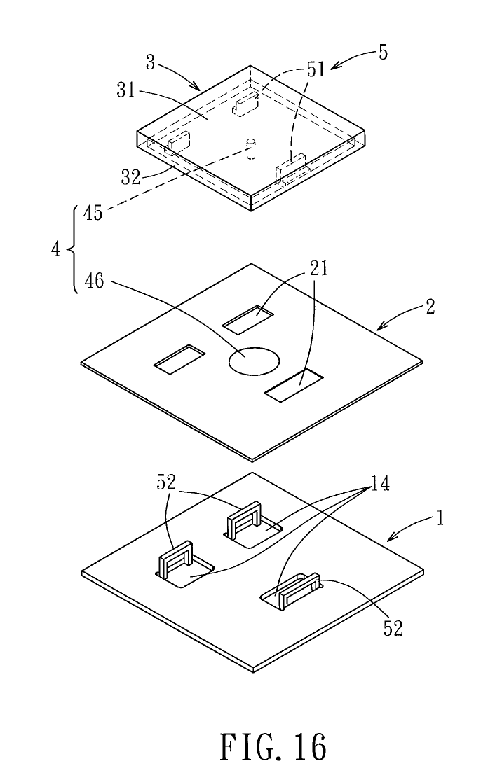

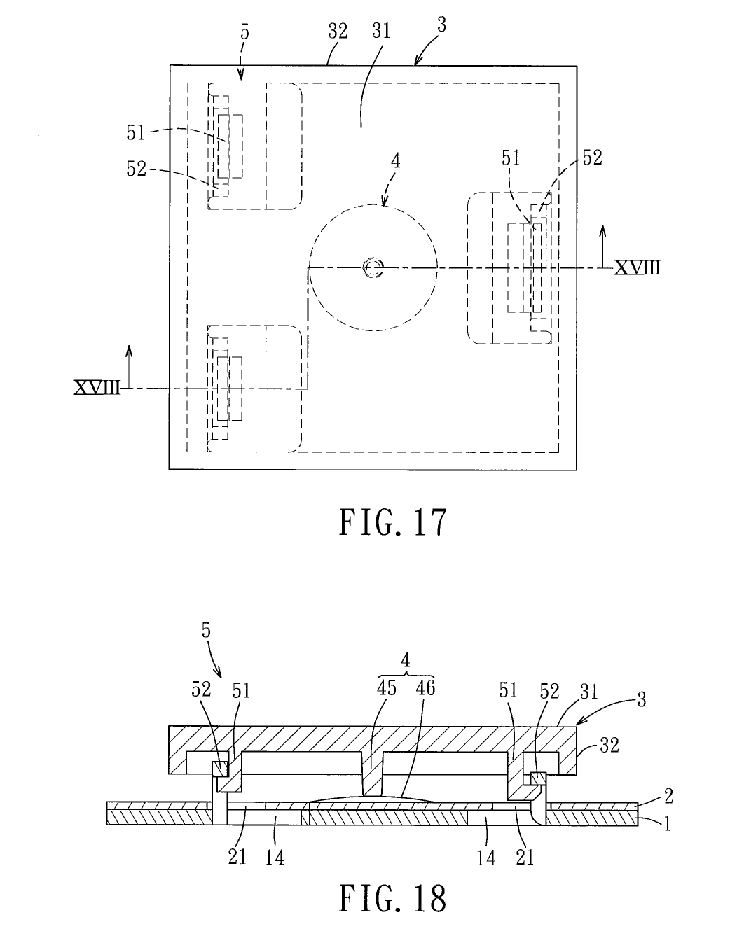

FIGS. 16 to 18 illustrate the sixth preferred embodiment of the press key according to this invention. The sixth preferred embodiment differs from the fifth preferred embodiment in that the elastic restoring unit 4 has a different configuration. In this embodiment, the elastic restoring unit 4 is identical to that in the second preferred embodiment.

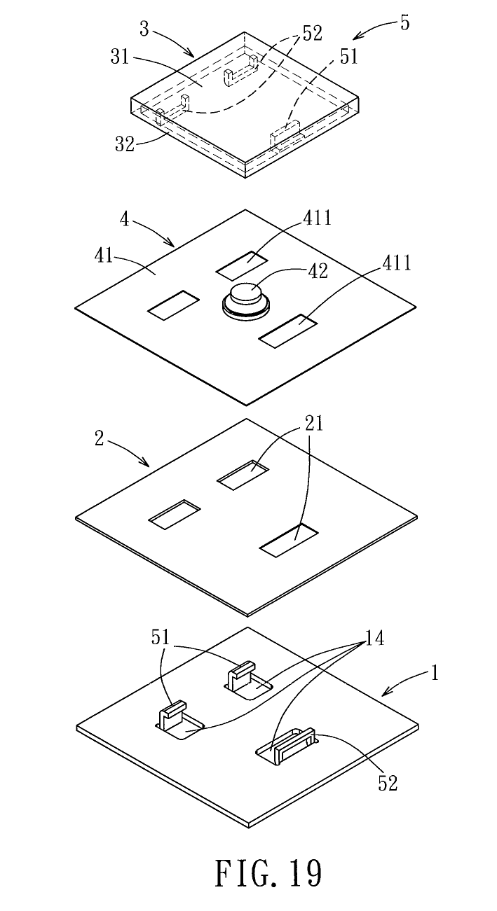

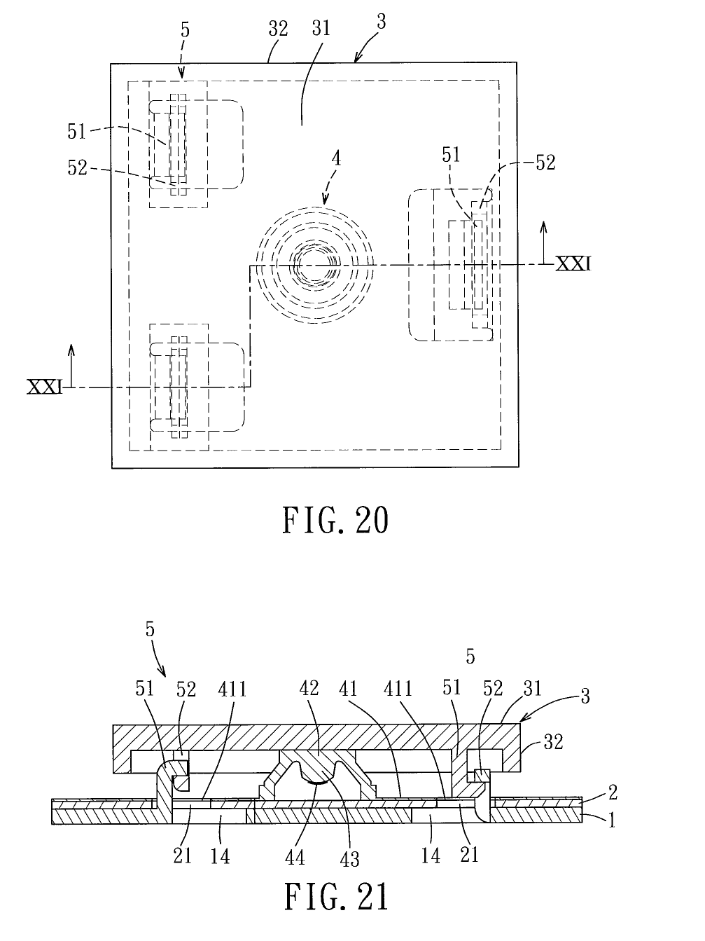

FIGS. 19 to 21 illustrate the seventh preferred embodiment of the press key according to this invention. The seventh preferred embodiment differs from the fifth preferred embodiment in that two of the guiding units 52 disposed on the base unit 1 are replaced by two engaging units 51, and that two of the engaging units 51 disposed on the keycap 3 are replaced by two guiding units 52.

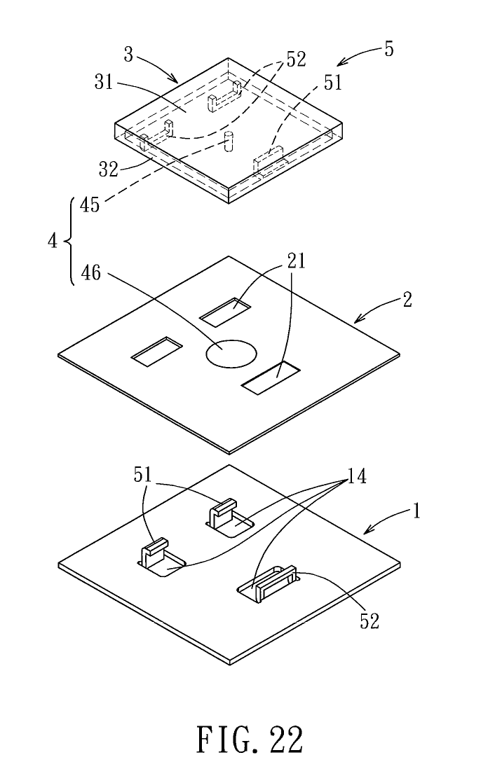

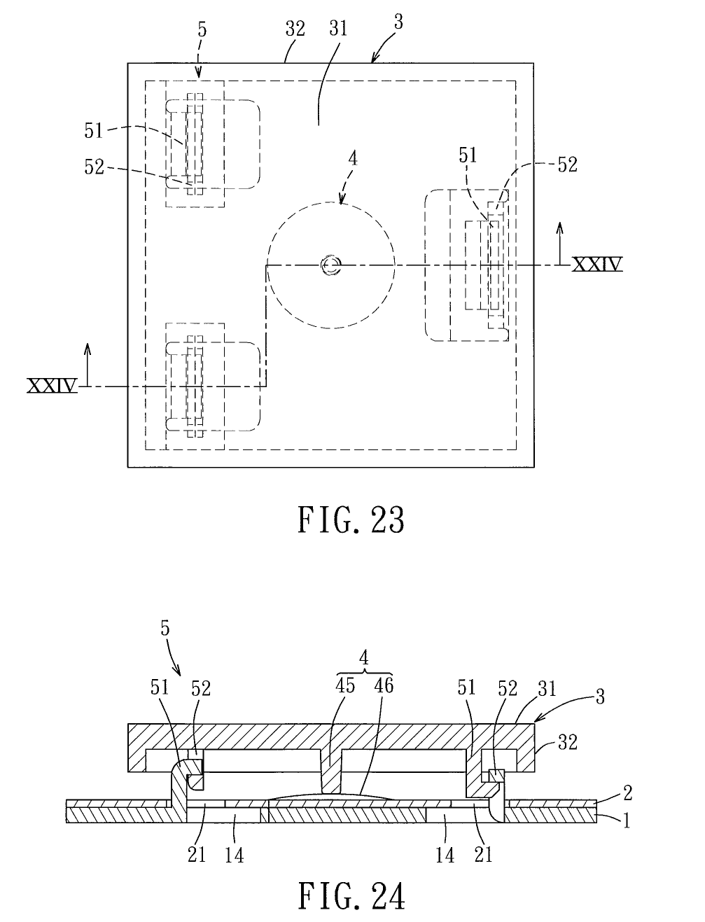

FIGS. 22 to 24 illustrate the eighth preferred embodiment of the press key according to this invention. The eighth preferred embodiment differs from the seventh preferred embodiment in that the elastic restoring unit 4 has a different configuration. In this embodiment, the elastic restoring unit 4 is identical to that in the second preferred embodiment.

By virtue of the guiding mechanism 5, the press key of this invention has a relatively simple structure and a reduced thickness, and the elements of the press key can be easily assembled together.

While the present invention has been described in connection with what are considered the most practical and preferred embodiments, it is understood that this invention is not limited to the disclosed embodiments but is intended to cover various arrangements included within the spirit and scope of the broadest interpretations and equivalent arrangements.

What is claimed is:

1. A press key comprising:
a base unit;
a circuit board disposed on said base unit;
a keycap disposed on said circuit board and movable between a raised position and a pressed position;
an elastic restoring unit disposed between said keycap and said circuit board, and capable of providing a restoring force to move said keycap to said raised position; and
a guiding mechanism to guide movement of said keycap, said guiding mechanism including at least one guiding unit disposed on one of said keycap and said base unit, and at least one engaging unit disposed on the other of said keycap and said base unit, said guiding unit and said engaging unit movably engaging with each other.

2. The press key of claim 1, wherein said guiding unit is formed with a guiding groove, and said engaging unit includes a shaft member engaging said guiding groove such that said guiding unit is in sliding engagement with said shaft member.

3. The press key of claim 2, wherein said guiding unit includes two spaced apart protrusions each having a free end bent toward the other of said protrusions, said protrusions cooperatively defining said guiding groove.

4. The press key of claim 3, wherein said engaging unit further includes two spaced apart supporting members to support two opposite ends of said shaft member.

5. The press key of claim 4, wherein said engaging unit is disposed on said base unit, said supporting members extending from said upper surface of said base unit, said protrusions of said guiding unit extending downwardly from said keycap.

6. The press key of claim 3, wherein said guiding mechanism includes four of said guiding units and two of said engaging units, said shaft member of each of said engaging units having two opposite ends that engage respective two of said guiding units.

7. The press key of claim 6, wherein said guiding units are disposed on a lower surface of said keycap, and said engaging units are disposed on an upper surface of said base unit, each of said engaging units further including a supporting body to support said shaft member, a bottom surface of said supporting body being formed with a plurality of pillars, said base unit being formed with a plurality of mounting holes to receive said pillars.

8. The press key of claim 1, wherein said guiding unit is formed with a guiding slot, and said engaging unit is an engaging hook movably engaging said guiding slot.

9. The press key of claim 1, wherein said guiding unit is disposed on a lower surface of said keycap, said engaging unit is disposed on an upper surface of said base unit, and said base unit is formed with at least one through slot for extension of said guiding unit.

10. The press key of claim 1, wherein said elastic restoring unit includes a truncated cone-shaped hollow body, and a contact extending downwardly from an inner face of a top side of said truncated cone-shaped hollow body, said contact being moved to contact said circuit board when said keycap is at said pressed position.

11. The press key of claim 1, wherein said elastic restoring unit includes a press member protruding from a lower surface of said keycap, and a springy metal dome disposed on said circuit board, a central portion of said springy metal dome being pressed by said press member to contact said circuit board when said keycap is at said pressed position.
